(19) United States
(12) Patent Application Publication
(10) Pub. No.: US 2026/0017961 A1
(43) Pub. Date: Jan. 15, 2026

(54) METHOD FOR IMAGE PROCESSING, METHOD FOR IMAGE LABELING AND IMAGE LABELING SYSTEM

(71) Applicant: INNOPEAK TECHNOLOGY, INC., Palo Alto, CA (US)

(72) Inventors: Yikang LI, Palo Alto, CA (US); Shichao XU, Palo Alto, CA (US); Jenhao HSIAO, Palo Alto, CA (US); Chiu Man HO, Palo Alto, CA (US)

(73) Assignee: INNOPEAK TECHNOLOGY, INC., Palo Alto, CA (US)

(21) Appl. No.: 18/993,690

(22) PCT Filed: Dec. 23, 2022
(86) PCT No.: PCT/US2022/082373

§ 371 Date: Jan. 13, 2025

Related U.S. Application Data
(60) Provisional application No. 63/397,069, filed on Aug. 11, 2022.
(60) Provisional application No. 63/397,065, filed on Aug. 11, 2022.

(51) Int. Cl. G06V 20/70; G06T 3/40; G06T 7/11; G06V 10/44

(52) U.S. Cl. CPC G06V 20/70; G06T 3/40; G06T 7/11; G06V 10/44; G06V 2201/07

(57) ABSTRACT

The present invention is directed to image classification techniques. In a specific embodiment, the present invention provides an image processing method. An input image is divided into a first plurality of patches and down-sampled to generate a first intermediate image. The first plurality of patches and the first intermediate image are used to generate a plurality of image tokens, which is used to train a deep learning model for image classification. A textual embedding extracted from a text input is used to guide the plurality of image tokens via an attention mechanism during the training process. There are other embodiments as well.

### CROSS-REFERENCES TO RELATED APPLICATIONS

The present application claims priority to U.S. Provisional Application No. 63/397,065, entitled “Dual-Modality Fusion Decoder for (zero-shot) Multi-Label Classification with Vision-Language Pre-training Model,” filed on Aug. 11, 2022, and U.S. Provisional Application No. 63/397,069, entitled “Pyramid-Forwarding Strategy for Zero-shot Multi-Label Classification with Vision-Language Pre-training Model,” filed on Aug. 11, 2022, which are commonly owned and incorporated by reference herein for all purposes.

### BACKGROUND OF THE INVENTION

As more and more multimedia data are stored online, recognizing and retrieving images from a large amount of digital media content has become ubiquitous. Various cloud services offered various types of automatic image labeling. For example, image classification has been widely used to categorize digital images based on the content or objects contained therein, thereby allowing accurate and efficient retrial.

There have been various conventional techniques for image classification, but they have been inadequate, for the reasons provided below. Therefore, new and improved methods and systems are desired.

### BRIEF SUMMARY OF THE INVENTION

The present invention is directed to image classification techniques. In a specific embodiment, the present invention provides an image processing method. An input image is divided into a first plurality of patches and down-sampled to generate a first intermediate image. The first plurality of patches and the first intermediate image are used to generate a plurality of image tokens, which is used to train a deep learning model for image classification. A textual embedding extracted from a text input is used to guide the plurality of image tokens via an attention mechanism during the training process. There are other embodiments as well.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for image processing, which includes receiving an input image characterized by a first dimension. The method also includes obtaining a first plurality of patches by dividing the first input image. The method also includes generating a first intermediate image by performing down-sampling using the input image, the first intermediate image being characterized by a second dimension, the second dimension being smaller than the first dimension. The method also includes obtaining a second plurality of patches by dividing the first intermediate image. The method also includes generating a second intermediate image by performing down-sampling using the first intermediate image, the second intermediate image being characterized by a third dimension, the third dimension being smaller than the second dimension. The method also includes performing object recognition using at least the first plurality of patches and the second plurality of patches. The method also includes generating one or more labels based on the object recognition. The method also includes storing the one or more labels. Other embodiments of this aspect include corresponding computer systems, apparatus, and computer programs recorded on one or more computer storage devices, each configured to perform the actions of the methods.

Implementations may include one or more of the following features. The method may include performing text recognition on the first plurality of patches. The method may include obtaining a first plurality of feature tokens using at least the first plurality of the patches. The second dimension is no greater than half of the first dimension, and the third dimension is no greater than the second dimension. The method may include performing the object recognition using the second intermediate image. The method may include generating a stack using at least the first plurality of patches and the second plurality of patches. The method may include performing iterative decoding processes using the stack. The method may include embedding the one or more labels in an output image. Implementations of the described techniques may include hardware, a method or process, or computer software on a computer-accessible medium.

One general aspect includes a method for image labeling. The method also includes obtaining a first image and a plurality of text data, the first image being characterized by a first dimension. The method also includes generating a first plurality of patches using the first image. The method also includes generating a second image based on the first image, the second image being characterized by a second dimension, the second dimension being lower than the first dimension. The method also includes extracting a textual embedding using the plurality of text data. The method also includes generating a plurality of visual embeddings using at least the first plurality of patches and the second image. The method also includes performing object recognition using at least plurality of visual embeddings and the textual embedding. The method also includes generating one or more labels based on the object recognition. The method also includes storing the one or more labels. Other embodiments of this aspect include corresponding computer systems, apparatus, and computer programs recorded on one or more computer storage devices, each configured to perform the actions of the methods.

Implementations may include one or more of the following features. The method may include generating a first key and a first value using at least the plurality of visual embeddings. The method may include generating a first query using at least the textual embedding. The method may include calculating a correlation between the textual embedding and the plurality of visual embeddings. Two adjacent patches of the first plurality of patches may be partially overlapped. The first dimension of the first image is greater than 224×224. Implementations of the described techniques may include hardware, a method or process, or computer software on a computer-accessible medium.

One general aspect includes an image labeling system. The image labeling system also includes a communication interface configured to receive an input image. The system also includes a memory coupled to the communication interface. The memory is configured to store the input image. The system also includes a processor coupled to the memory, the processor being configured for: obtaining a first plurality of patches by dividing the first input image; generating a first intermediate image by performing down-sampling using the input image, the first intermediate image being characterized by a second dimension, the second dimension being smaller than the first dimension; obtaining a second plurality of patches by dividing the first intermediate image; generating a second intermediate image by performing down-sampling using the first intermediate image, the second intermediate image being characterized by a third dimension, the third dimension being smaller than the second dimension; performing object recognition using at least the first plurality of patches and the second plurality of patches; generating one or more labels based on the object recognition. Other embodiments of this aspect include corresponding computer systems, apparatus, and computer programs recorded on one or more computer storage devices, each configured to perform the actions of the methods.

Implementations may include one or more of the following features. The processor may include a central processing unit (CPU). The processor may include a neural processing unit (NPU) and/or a graphics processing unit (GPU). The processor is further configured for embedding the one or more labels in an output image. The system may include a data storage configured to store the one or more labels and the output image. The processor is further configured for obtaining a plurality of feature tokens using at least the first plurality of the patches and the second plurality of patches. Implementations of the described techniques may include hardware, a method or process, or computer software on a computer-accessible medium.

The embodiments of the present invention, using machine learning techniques, efficiently and accurately classify an image into one or more classes. The embodiments of the present invention provide many advantages over conventional techniques. Among other things, the present invention provides image preprocessing methods to enhance the performance for high-resolution images (e.g., 224×224, 336×336 or higher) without increasing the computational cost. Dual-modal decoders are implemented to explore the alignment of textual and visual embeddings to provide multi-label classification results with high accuracy. Additionally, the image labeling system of the present invention provides a robust solution in zero-shot scenarios where the unseen classes in unseen images can be identified to improve classification accuracy. There are other benefits as well.

The present invention achieves these benefits and others in the context of known technology. However, a further understanding of the nature and advantages of the present invention may be realized by reference to the latter portions of the specification and attached drawings.

### BRIEF DESCRIPTION OF THE DRAWINGS

FIG. 1 is a simplified block diagram illustrating system 100 for image classification according to the embodiments of the present invention.

FIG. 2 is a simplified block diagram illustrating data flow 200 for image classification according to the embodiments of the present invention.

FIG. 3 is a simplified diagram illustrating method 300 for image processing according to the embodiments of the present invention.

FIG. 4 is a simplified flow illustrating diagram data flow 400 for image classification according to the embodiments of the present invention.

FIG. 5 is a simplified flow diagram illustrating method 500 for image processing according to embodiments of the present invention.

FIG. 6 is a simplified flow diagram illustrating method 600 for image labeling according to embodiments of the present invention.

### DETAILED DESCRIPTION OF THE INVENTION

The present invention is directed to image classification techniques. In a specific embodiment, the present invention provides an image processing method for image labeling. An input image is divided into a first plurality of patches and down-sampled to generate a first intermediate image. The first plurality of patches and the first intermediate image are used to generate a plurality of image tokens, which is used to train a deep learning model for image classification. A textual embedding extracted from a text input is used to guide the plurality of image tokens via an attention mechanism during the training process. There are other embodiments as well.

Over the years, many techniques for image classification have been developed, including both traditional and deep learning approaches. Deep learning approaches—such as neural networks trained with pre-labeled datasets—provide a scalable solution to tackle the increasing number of label classes as the volume of data grows exponentially. Many existing approaches rely on single-label classification, which assumes that each image contains only one item, scene, or concept of interest to label and can be limiting in realistic scenarios involving multiple objects. Multi-label classification, on the other hand, aims to generate labels for the multiple objects contained in an image, thereby providing a more comprehensive understanding of the image scene. However, it remains a challenging task to recognize objects in the image accurately and efficiently, especially when the object of interest has not been seen during the previous training process.

Embodiments of the present invention provide a complete image classification system for assigning multiple labels to the input image based on the image elements contained therein, which allows for efficient retrieval of images in response to a given query keyword. The present invention implements various deep learning strategies to enhance generality and usability. For example, the system employs an image preprocessing mechanism to increase its compatibility with images characterized by various resolutions (e.g., 224×224 or higher). The resulting system can identify the previously seen object categories (referred to as “conventional multi-label classification”) and even recognize the previously unseen object categories (referred to as “zero-shot multi-label classification”). Overall, embodiments of the present invention achieve competitive classification results for various types of input images.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counterclockwise have been used for convenience purposes only and are not intended to imply any particular fixed direction. Instead, they are used to reflect relative locations and/or directions between various portions of an object.

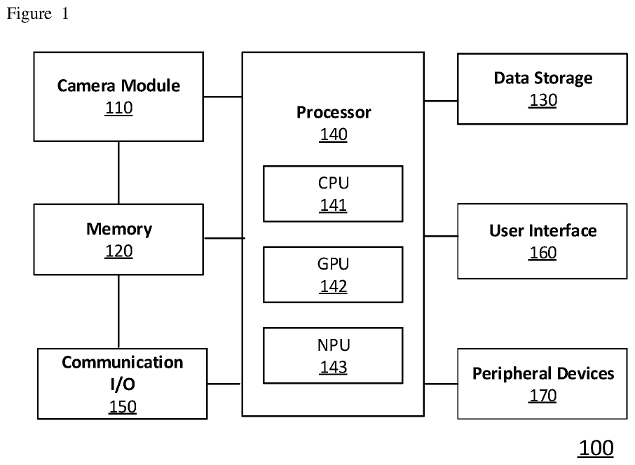

FIG. 1 is a simplified block diagram illustrating system 100 for image classification according to the embodiments of the present invention. This diagram is merely an example, which should not unduly limit the scope of the claims. One of ordinary skill in the art would recognize many variations, alternatives, and modifications.

As shown, system 100 includes camera module 110, memory 120, data storage 130, processor 140, and communication interface 150. Memory 120 is coupled to communication interface 150, which is configured to obtain an input image and a plurality of text data. In another example, a first image may be captured by camera module 110 and stored in memory 120. Memory 120 may include a random-access memory (RAM) device, an image buffer device, or the like. In some cases, the input image includes one or more objects. The plurality of text data includes label class information. For example, one or more label classes of the plurality of text data correspond to one or more objects contained in the first image.

In various implementations, data storage 130 is configured to store a pre-trained model, which is used to align visual and textual features. Data storage 130 may include, without limitation, local and/or network-accessible storage, a disk drive, a drive array, an optical storage device, and a solid-state storage device, which can be programmable, flash-updateable, and/or the like. Processor 140 can be coupled to each of the previously mentioned components and be configured to communicate between these components. In a specific example, processor 140 includes central processing unit (CPU) 141, graphics processing unit (GPU) 142, and/or network processing unit (NPU) 143, or the like. For example, each of the processing units may include one or more processing cores for parallel processing. In a specific embodiment, CPU 141 includes both high-performance cores and energy-efficient cores.

In some embodiments, system 100 further includes user interface 160. For example, user interface 160 is configured to display an output image in response to user input. The output image may include one or more labels corresponding to the object(s) contained therein. In some cases, user interface 160 comprises a touchscreen display (e.g., in a mobile device, tablet, etc.), which can receive the user's query (e.g., a label class) as input for image search and display the search results (e.g., one or more images containing objects of the class). In various implementations, system 100 further includes one or more peripheral devices 170 configured to improve user interaction in various aspects. For example, peripheral devices 170 may include, without limitation, at least one of the speaker(s) or earpiece(s), audio sensor(s) or microphone(s), noise sensors, keyboard, mouse, and/or other input/output devices.

In a specific example, processor 140 includes central processing unit (CPU) 141, graphics processing unit (GPU) 142, and/or neural network processing unit (NPU) 143, or the like. CPU 141 may be configured to handle various types of system functions, such as retrieving the input image and the plurality of text data from memory 120, and executing executable instructions (e.g., feature extraction, feature alignment, feature mapping, etc.). In some embodiments, GPU 142 may be specially designed to facilitate image processing. For example, GPU 142 is configured to convert the input image into a plurality of patches/spatial regions for image preprocessing. In some cases, the GPU may further perform a downsampling function that involves rate-reduction or bandwidth reduction during the image preprocessing. NPU 143 can be configured to perform model training processes and other machine/deep learning-related processes. In various implementations, NPU 143 embedded in the processor 140 comprises a data-driven parallel computing architecture and is specialized for processing large amount of image and text data. For example, NPU 143 includes modules that implement an encoder-decoder architecture for performing multi-head cross-attention, feedforward, add and normalization, softmax, dot product, and/or other functions in a neural network.

Other embodiments of this system include corresponding computer systems, apparatus, and computer programs recorded on one or more computer storage devices, each configured to perform the actions of the methods. Elements of system 100 can be configured together to perform an image classification process to determine correlations between one or more label classes and one or more objects included in the input image, as further described below.

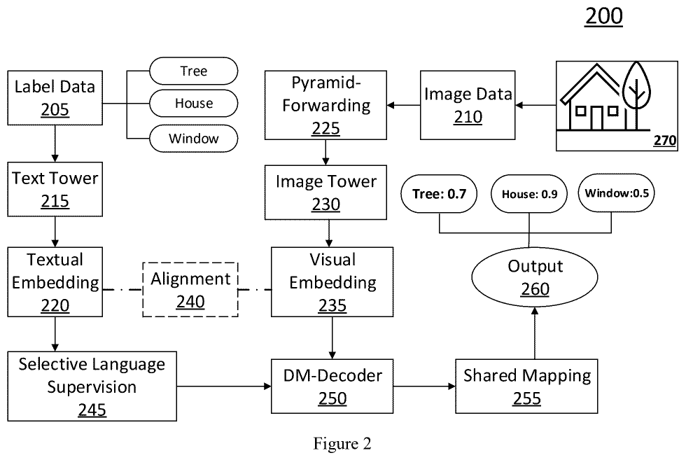

FIG. 2 is a simplified block diagram illustrating data flow 200 for image classification according to the embodiments of the present invention. This diagram is merely an example, which should not unduly limit the scope of the claims. One of ordinary skill in the art would recognize many variations, alternatives, and modifications. For example, one or more steps may be added, removed, repeated, replaced, modified, rearranged, and/or overlapped, and they should not limit the scope of the claims.

According to an example, the present invention provides a method to identify and/or predict one or more label classes of the image input by analyzing the correlations between the image and text inputs. As shown, data flow 200 starts with receiving label data 205 and image data 210. For example, label data 205 includes a plurality of label classes in natural language words for potentially describing the objects (e.g., tree, apple, computer, etc.), scenes (e.g., sea, sky, undergrounds, etc.), or concepts (e.g., small, red, high, etc.) of interests contained in an image. As the example shown in FIG. 2, label data 210 includes label classes such as tree, house, window, etc. Depending on the implementation, label data 205 may first be combined with a textual prompt (e.g., “This photo contains . . . ”) before being fed into text tower 215 for feature extraction. Text tower 215 is configured to generate textual embedding 220 using at least the label data 205.

The first image may include one or more objects/scenes/concepts. As the example shown in FIG. 2, image data 210 includes first image 270 depicting a scene of one's residence, which includes objects such as trees, a house, and a window. In various implementations, image data 210 is processed in parallel with label data 205. Image data 210 may be first sent to pyramid-forwarding module 225 for preprocessing to enhance the performance for inputs with high resolutions (e.g., 224×224 or higher). Pyramid-forwarding module 225 is configured to divide the input image into a plurality of patches and/or perform a down-sampling function to generate one or more intermediate images. The plurality of patches and the one or more intermediate images can be used to generate image feature tokens.

In various implementations, to boost the system performance under various conditions (e.g., zero-shot multi-label classification or the like), textual embedding 220 and visual embedding 235 may be aligned at alignment module 240 via a pre-trained model based on the correlation between text and image. For instance, the pre-trained model is trained on a variety of image-text pairs and can predict the most relevant text description in response to an image input. The pre-trained model may be stored in a data storage (e.g., data storage 130 of FIG. 1). In an example of zero-shot multi-label classification, the training data contains the images {x_{(img, seen)}} and the labels X_{(lbl, seen)}. The objective is to learn a classifier g to make predictions on an unseen image x_{(img, unseen)} with unseen categories X_{(lbl, unseen)}. To improve the system's generalizability to unseen categories, the relationship between the visual and textual embeddings is further explored in alignment module 240. At alignment module 240, an additional soft constraint may be applied on the visual embedding 235 and textual embedding 220 as:

$$\{ \begin{matrix}g ( {f}_{img} ( {x}_{( img , unseen )} ) , {f}_{lbl} ( {x}_{( ll , unseen )} ) ) ∈ \{ 0 , 1 \} . \\ cos ( \frac{{f}_{img} ( {x}_{( img , unseen )} )}{\vert {f}_{img} ( {x}_{( img , unseen )} )} , \frac{{f}_{lbl} ( {x}_{( lbl , unseen )} )}{\vert {f}_{lbl} ( {x}_{( lbl , unseen )} ) \vert} \to 1 - ϵ , \\ if g ( {f}_{img} ( {x}_{( img , unseen )} ) , {f}_{lbl} ( {x}_{( lbl , unseen )} ) ) = 1 , else ϵ ,\end{matrix} \qquad ( Eqn . 1 )$$

where f_{img} denotes the image encoder, f_{lbl} denotes the text encoder, and ϵ is a small value determined by the pre-trained model to convert the multi-label classification into a regression task: given the inputs {(a, b)}, and the corresponding label {l}

$$( l = 1 if cos \frac{a}{\vert a \vert} , \frac{b}{\vert b \vert} ) = 1 - ϵ ,$$

else 0), learn a model g that satisfies:

$$g ( \frac{a}{\vert a \vert} , \frac{b}{\vert b \vert} ) = 1 \qquad ( Eqn . 2 )$$

Depending on the implementation, selective language supervision 245 may be applied to selectively utilize the input label classes during the training process to reduce computational cost and memory usage while ensuring the training performance. For example, given multi-label L={l₁, l₂, . . . , lₖ} from a training batch B with k classes in total, a number of positive labels Sₚₒₛ={i|lᵢ=1, lᵢ∈L, L∈B} and a number of negative labels S_{neg}={1, 2, . . . , k}−Sₚₒₛ are selected, and the selected label set for batch B training is:

$${S}^{′} = {S}_{p o s} ⋃ {S}_{slt} \qquad ( Eqn . 3 )$$

where elements in Sₛₗₜ are randomly selected from S_{neg}|Sₛₗₜ|=min (α*|Sₚₒₛ|, k−|Sₚₒₛ|), α is a hyper-parameter balancing the number of positive and negative samples (e.g., α=3). It is to be appreciated that selective language supervision 245—in consideration of balanced sample data distribution—can reduce the number of labels involved in the training process, enabling the system to scale well to a large number of label classes (e.g., greater than 1 k).

In various embodiments, the aligned textual embedding 220 (e.g., after the selective language supervision 245) and visual embedding 235 are fed into dual-modal decoder (“DM-decoder”) 250 to determine the probability value of each label class in label data 205 with respect to the objects/scenes/concepts contained in image data 210 (e.g., first image 270). For example, the probability value indicates the relevance between one or more objects/scenes/concepts and each label class. The higher the probability value, the more likely the corresponding label class can be used to tag the image for classification. Depending on the implementations, DM-decoder 250 may comprise a single-layer architecture or a multi-layer architecture (e.g., six-layer). DM-decoder 250 facilitates the fusion of the semantics from a dual-modal information source (i.e., image and text) with an initial query from textual embedding 220 and an initial key-value pair from visual embedding 235.

The output of DM-decoder 250 is later forwarded to shared mapping module 255 to perform a shared mapping among all labels and generate the probability value for each label class as output 260. As the example shown in FIG. 2, output 260 of system 200 includes the probability value for each of the input label classes (Tree: 0.7; House: 0.9; Window: 0.5).

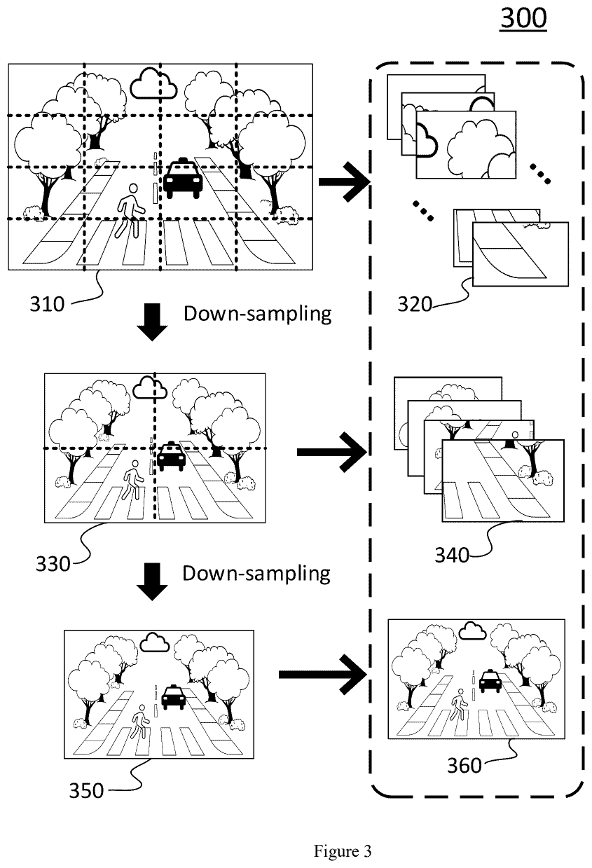

FIG. 3 is a simplified diagram illustrating method 300 for image processing according to the embodiments of the present invention. This diagram is merely an example, which should not unduly limit the scope of the claims. One of ordinary skill in the art would recognize many variations, alternatives, and modifications.

In various implementations, embodiments of the present invention deploy an attention-based encoder-decoder architecture for image classification by exploring the correlation between the visual and textual features, of which the computational complexity increases significantly for input images with higher resolutions (e.g., 336×336 or higher). According to an example, method 300 is implemented for preprocessing the input images to enhance the system's resolution compatibility with various modes of images. Referring to FIG. 2, pyramid-forwarding module 225 may be employed to implement method 300 for image preprocessing.

As shown in FIG. 3, pyramid-forwarding module 225 receives input image 310, which is characterized by a first dimension (e.g., 224×224, 336×336, or higher). Depending on the scene, small objects may be confined in a small region, but needs to be identified at full resolution (e.g., image patches as shown). In contrast, large objects occupying a large area of the input image 130 may be efficiently recognized at a down-sampled resolution (e.g., intermediate image 350) that is much lower than the input image resolution. A plurality of patches 320 may be generated using input image 310. Each of the plurality of patches has a fixed size. Pyramid-forwarding module 225 may further perform a down-sampling on input image 310 to generate first intermediate image 330, which is characterized by a second dimension. The second dimension is smaller than the first dimension. In some cases, first intermediate image 330 is divided into a second plurality of patches 340. For example, patches 320 and patches 340 at different resolution are suitable for object recognition at different sizes relative to the input image. In various embodiments, each of the second plurality of patches 340 has a fixed size, and they can be generated quickly from first intermediate image 330. Depending on the implementation, a second intermediate image 350 may be generated by performing down-sampling using first intermediate image 330. The second intermediate image 350 is characterized by a third dimension, which is smaller than the second dimension. Second intermediate image 350 can serve as a single patch 360, which is later fed into an image encoder (not shown) together with the first plurality of patches 320 and the second plurality of patches 340 for further processing.

In a specific example, the image encoder includes a deep-learning model trained on images with S_{img}×S_{img} resolution and input image 310 has a size of S_{img}*d×S_{img}*d. Pyramid-forwarding module 225 constructs log (d)+1 levels. If log (d) is an integer, in level i∈[0 . . . log (d)], the image is resized to S_{img}*2ⁱ×S_{img}*2ⁱ and split into (i+1)×(i+1) patches. These patches may later be fed into an image encoder (e.g., wrapped into the batch dimension for parallel processing on GPUs) to generate feature tokens. The feature tokens may then be stacked on the token dimension and fed into a decoder (e.g., DM-decoder 250 of FIG. 2) for object recognition.

It is to be appreciated that by processing image patches at different resolutions, high levels of efficiency and accuracy can be achieved. Without the image preprocessing process, the computation cost on the S_{img}*d×S_{img}*d would be O((d²)²)=O(d⁴) times more than the S_{img}×S_{img} image due to the attention mechanism implemented by the decoder. In comparison, image processing method 300 allows the computational cost to be reduced to 1+2²+4²+ . . . +(2^{log(d)})²˜O(d²). If log (d) is not an integer, the size of the top-level image may be changed to S_{img}^{O}, and the divided patches can be partially overlapped with their neighbors, while the total number of patches in this level remains (i+1)². Depending on the implementation, the computational cost can be further reduced by randomly disposing the image patches from the non-bottom levels i∈[1 . . . log (d)].

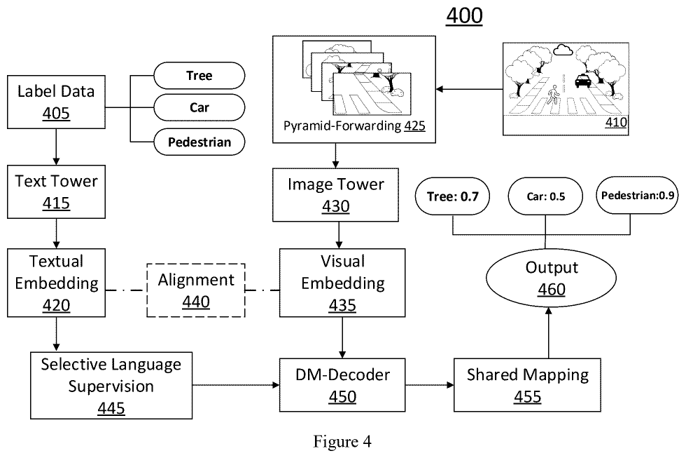

FIG. 4 is a simplified flow illustrating diagram data flow 400 for image classification according to the embodiments of the present invention. This diagram is merely an example, which should not unduly limit the scope of the claims. One of ordinary skill in the art would recognize many variations, alternatives, and modifications. For example, one or more steps may be added, removed, repeated, replaced, modified, rearranged, and/or overlapped, and they should not limit the scope of the claims.

As shown, data flow 400 starts with receiving label data 405 and input image 410. Input image 410 is characterized by a first dimension (e.g., 224×224, 336×336, etc.). Input image 410 may include one or more objects/scenes/concepts. As the example shown in FIG. 4, input image 410 includes elements such as trees, cars, pedestrians, etc. In various implementations, input image 410 may be processed by pyramid-forwarding module 425 for preprocessing to enhance the resolution compatibility with various types of image inputs.

According to some embodiments, label data 405 is processed in parallel with the input image 410. For example, label data 405 includes a plurality of label classes in natural language words for potentially describing the elements contained in input image 405. As the example shown in FIG. 4, label data 410 includes label classes such as tree, car, pedestrian, etc. Label data 410 may then be fed into a text tower 415 for feature extraction to generate textual embedding 420. For example, label data 410 may be obtained through machine learning using millions of images.

In a specific example, input image 410 is divided into a first plurality of patches at pyramid-forwarding module 425. Pyramid-forwarding module 425 also performs a down-sampling function on input image 410 to generate a first intermediate image, which is then used to generate a second intermediate image via a similar down-sampling process. The first intermediate image may be divided into a second plurality of patches. The first and second plurality of patches may be later fed to an image encoder for feature extraction. In some cases, the first and second plurality of patches, together with the second intermediate image, is fed into image tower 430 to generate visual embedding 435 (i.e., a sequence of feature tokens). For example, the first plurality of intermediate images are at full resolution and they are useful for small objects recognition, while the second plurality of intermediate images are at a lower resolution (½ or /14 of the size) that is suitable for recognizing relatively larger objects. Position embeddings may also be added to retain positional information. It is to be appreciated that the plurality of patches and the intermediate image(s) provide different levels of detail that are advantageous to enrich the semantic understanding for boosting the system performance.

In some cases, textual embedding 420 and visual embedding 435 may be aligned at alignment module 440 according to the correlation between the text and image. Depending on the implementations, selective language supervision 445 may be applied to selectively utilize the input label classes during the training process to reduce computational cost and memory usage while ensuring the training performance.

In various implementations, the first and second plurality of patches is stacked on the token dimension and then fed into a decoder for an iterative decoding process. For example, visual embedding 435 and textual embedding 420 (e.g., after selective language supervision processing) are forwarded to DM-decoder 450, which adopts an attention mechanism that correlates the image and text inputs by progressively fusing visual embedding 435 with textual embedding. For example, a first query is generated using textual embedding 420. A first key and a first value is generated using visual embedding 435. The first query, key, and value are fed into DM-decoder 450 as inputs to explore feature relatedness and determine the probability of each label class with respect to the elements contained in input image 410. In an example, given a query text, the aspects of the visual embedding to be emphasized may vary depending on the correlation between the visual and textual features.

In some embodiments, object recognition may be performed using at least the first plurality of patches and the second plurality of patches. For instance, DM-decoder 450 calculates the correlation between the first query and the first key to evaluate the relatedness between visual and textual features based on the attention mechanism. The relatedness among the image features is also evaluated for object recognition. It is to be appreciated that the plurality of patches (e.g., the first and second plurality of patches) provides different levels of detail that allow for accurate and comprehensive object recognition. A weighted sum of image tokens' embedding guided by the textual information can thus be obtained, which may be further refined with the second query generated from visual embedding 435. DM-decoder 450 leverages dual modality to determine per-class probability by exploring the feature relatedness and enriching semantic understanding.

DM-decoder 450 may comprise a single decoder layer or multiple decoder layers (e.g., six layers) with each layer having a similar architecture, and each of the layers may be configured to recognize one or more types of objects or texts. It is to be appreciated that the training performance can benefit from the increase of the network depth and stacking of the transformer decoder. Each decoder layer adopts a similar attention mechanism, which draws information from the outputs of the previous decoder layer. The output of DM-decoder 450 is later forwarded to shared mapping module 455 to perform a shared mapping among all labels and generate the probability value for each label class as output 460. As the example shown in FIG. 4, output 460 includes the probability value for each of the input label classes (Tree: 0.7; Car: 0.5; Pedestrian: 0.9).

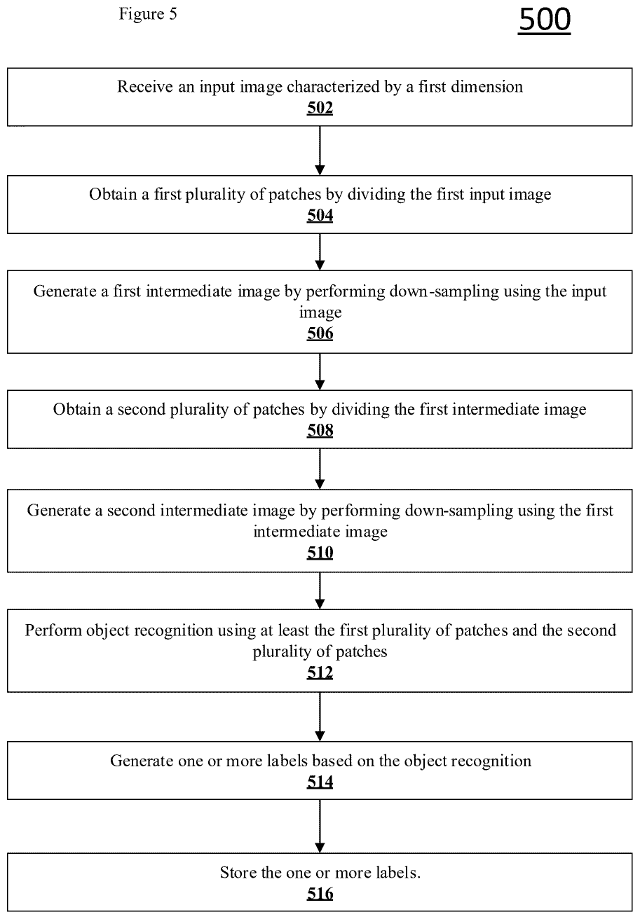

FIG. 5 is a simplified flow diagram illustrating method 500 for image processing according to the embodiments of the present invention. This diagram is merely an example, which should not unduly limit the scope of the claims. One of ordinary skill in the art would recognize many variations, alternatives, and modifications. For example, one or more steps may be added, removed, repeated, replaced, modified, rearranged, and/or overlapped, and they should not limit the scope of the claims.

According to an example, the method for image processing can be performed by a computing system, such as system 100 of FIG. 1. As shown, method 500 includes step 502 of receiving an input image characterized by a first dimension. The input image may be obtained by network transfer or user upload and serve as the training data to train system 100 for categorizing the input image into one or more classes using deep learning strategies. The first image includes one or more objects/scenes/concepts and is characterized by a predetermined dimension (e.g., 224×224, 336×336, or higher).

In step 504, the method includes obtaining a first plurality of patches by diving the first image. Referring to system 100 of FIG. 1, the input image and text data may be stored at memory 120 and retrieved by processor 140 to generate the first plurality of patches. Each of the first plurality of the patches has a fixed size (e.g., 224×224), and the “dividing” operation can be performed quickly and efficiently. The first plurality of patches may later be used to generate a first plurality of feature tokens (e.g., implemented with processor 140 of FIG. 1).

In step 506, the method includes generating a first intermediate image by performing down-sampling using the input image. For example, processor 140 of FIG. 1 is configured to perform a down-sampling function that involves rate-reduction or bandwidth reduction to generate the first intermediate image. The first intermediate image is characterized by a second dimension. The second dimension may be smaller than the first dimension. In an example, the second dimension of the first intermediate image is no greater than half of the first dimension of the input image.

In step 508, the method includes obtaining a second plurality of patches by dividing the first intermediate image. For example, processor 140 is configured to generate the second plurality of patches. Each of the second plurality of patches has a fixed size (e.g., 224×224). The second plurality of patches may later be forwarded to an image encoder for feature extraction. In an example, the first plurality of patches and the second plurality of patches may be used to generate visual embeddings which are stacked on the token size dimension and fed into a decoder (e.g., DM-decoder 450 of FIG. 4) for further processing. It is to be appreciated that the plurality of patches (e.g., the first and second plurality of patches) provides different levels of detail for enriching the semantic understanding.

In step 510, the method includes generating a second intermediate image by performing down-sampling using the first intermediate image. For example, processor 140 of FIG. 1 is configured to perform a downsampling function such as rate-reduction or bandwidth reduction to generate the second intermediate image. The second intermediate image is characterized by a third dimension. The third dimension may be smaller than the second dimension. In an example, the third dimension of the second intermediate image is no greater than the second dimension of the first intermediate image.

In step 512, the method includes performing object recognition using at least the first plurality of patches and the second plurality of patches. According to an example, the first and second plurality of patches may be used to generate a stack, which is then fed into the decoder for performing iterative decoding processes. The decoder adopts an attention mechanism that correlates the visual and textual embedding for object recognition and generates a weighted sum of image tokens' embedding guided by the textual information. The relatedness among the image features may also be explored for object recognition based on the correlation between the visual and textual embedding. The second intermediate image may also be used to perform object recognition. In some cases, the method further includes performing text recognition on the first plurality of patches.

In steps 514 and 516, the method includes generating one or more labels based on the object recognition and storing the one or more labels. In an example, the output of the decoder is received by a feedforward neural network to perform a shared mapping among all labels to generate the per-class probability. The one or more labels corresponding to the elements of the input image can be determined based on the probability value. For example, if the probability value of a class is above a predetermined threshold, the input image will be tagged with the corresponding label class. The one or more labels may be stored in a data storage (e.g., data storage 130 of FIG. 1). In some embodiments, the method further includes embedding the one or more labels in an output image, which can be retrieved and displayed in response to a user's search query that includes at least one of the labels embedded in the image.

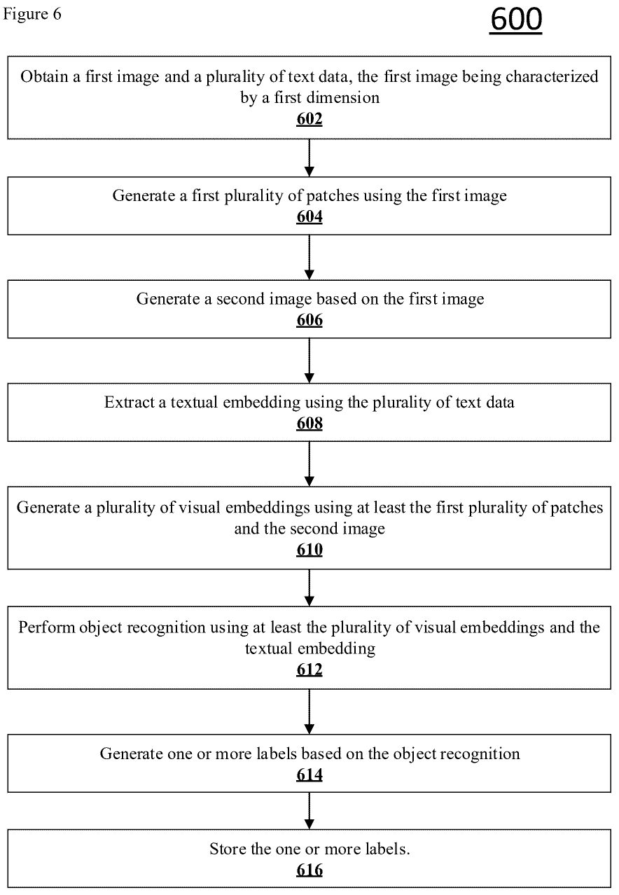

FIG. 6 is a simplified flow diagram illustrating method 600 for image labeling according to embodiments of the present invention. This diagram is merely an example, which should not unduly limit the scope of the claims. One of ordinary skill in the art would recognize many variations, alternatives, and modifications. For example, one or more steps may be added, removed, repeated, replaced, modified, rearranged, and/or overlapped, and they should not limit the scope of the claims.

According to an example, the method for image labeling can be performed by a computing system, such as system 100 of FIG. 1. As shown, the method includes step 602 of obtaining a first image and a plurality of text data. The first image and the plurality of text data may be obtained by network transfer or user upload and serve as the training data to train system 100 for categorizing the image input into one or more classes using deep learning strategies. In some embodiments, the plurality of text data includes label class information such as a plurality of label classes in natural language words for describing objects, scenes, and/or concepts of interests contained in an image. The first image includes one or more objects/scenes/concepts and is characterized by a first dimension (e.g., 224×224, 336×336, or higher).

In step 604, the method includes generating a first plurality of patches using the first image. Referring to system 100 of FIG. 1, the first image and text data may be stored at memory 120 and retrieved by processor 140 to generate the first plurality of patches. Each of the first plurality of the patches has a fixed size (e.g., 224×224). The first plurality of patches may later be used to generate a first plurality of feature tokens (e.g., implemented with processor 140 of FIG. 1). In some cases, two adjacent patches of the first plurality of patches may be partially overlapped.

In step 606, the method includes generating a second image based on the first image. For example, the second image is generated by performing down-sampling such as rate-reduction or bandwidth reduction on the first image. The second image is characterized by a second dimension. The second dimension may be smaller than the first dimension. In an example, the second dimension is no greater than half of the first dimension of the first image.

In step 608, the method includes extracting a textual embedding using the plurality of text data. Referring to system 100 of FIG. 1, processor 140 is configured to extract the textual embedding. Depending on the implementation, the plurality of text data may first be combined with a textual prompt (e.g., “This photo contains . . . ”) before being processed by processor 140 for feature extraction.

In step 610, the method includes generating a plurality of visual embeddings using at least the first plurality of patches and the second image. For example, the first plurality of patches and the second image may be fed into an image encoder for feature extraction to generate the plurality of visual embeddings (i.e., a sequence of feature tokens). Position embeddings may also be added to retain positional information. The first plurality of patches and the second image provide different levels of detail that are advantageous to enrich the semantic understanding for boosting the system performance. In some cases, to achieve better generalization ability under various conditions (e.g., zero-shot multi-label classification, and/or the like), the visual embedding is aligned with the textual embedding via a pre-trained model, which is based on the correlation between the text and image.

In step 612, the method includes performing object recognition using at least the plurality of visual embeddings and the textual embedding. For instance, the textual embedding and the plurality of visual embeddings are fused by a dual-modal decoder with the initial query from textual embedding the initial key/value from visual embeddings based on an attention mechanism. In an example, a first key and a first value are generated using at least the plurality of visual embeddings. A first query is generated using at least the textual embedding. The dual-modal decoder calculates a correlation between the visual and textual embedding for object recognition and generates a weighted sum of image tokens' embedding guided by the textual information. The relatedness among the image features tokens may also be explored for object recognition.

In steps 614 and 616, the method includes generating one or more labels based on object recognition and storing the one or more labels. In an example, the output of the dual-modality decoder is received by a feedforward neural network to perform a shared mapping among all labels to generate the per-class probability. The one or more labels corresponding to the elements of the input image can be determined based on the probability value. For example, if the probability value of a class is above a predetermined threshold, the input image will be tagged with the corresponding label class. The one or more labels may be stored in a data storage (e.g., data storage 130 of FIG. 1). In some embodiments, the method further includes embedding the one or more labels in an output image, which can be retrieved and displayed in response to a user's search query that includes at least one of the labels embedded in the image.

When performing the image classification tasks during an inference stage, one or more probability values may be used to determine one or more label classes associated with the one or more objects contained in the input image. Embodiments of the present invention provide state-of-the-art performance for various image classification tasks including, without limitation, conventional multi-label classification, zero-shot multi-label classification, single-to-multi-label classification, and/or the like. Implementations of the described techniques may include hardware, a method or process, or computer software on a computer-accessible medium.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method for image processing, the method comprising:
receiving an input image characterized by a first dimension;
obtaining a first plurality of patches by dividing the first input image;
generating a first intermediate image by performing down-sampling using the input image, the first intermediate image being characterized by a second dimension, the second dimension being smaller than the first dimension;
obtaining a second plurality of patches by dividing the first intermediate image;
generating a second intermediate image by performing down-sampling using the first intermediate image, the second intermediate image being characterized by a third dimension, the third dimension being smaller than the second dimension;
performing object recognition using at least the first plurality of patches and the second plurality of patches;
generating one or more labels based on the object recognition; and
storing the one or more labels.

2. The method of claim 1 further comprising performing text recognition on the first plurality of patches.

3. The method of claim 1 further comprising obtaining a first plurality of feature tokens using at least the first plurality of the patches.

4. The method of claim 1 wherein the second dimension is no greater than half of the first dimension, and the third dimension is no greater than the second dimension.

5. The method of claim 1 further comprising performing the object recognition using the second intermediate image.

6. The method of claim 1 further comprising generating a stack using at least the first plurality of patches and the second plurality of patches.

7. The method of claim 6 further comprising performing iterative decoding processes using the stack.

8. The method of claim 1 further comprising embedding the one or more labels in an output image.

9. A method for image labeling, the method comprising:
obtaining a first image and a plurality of text data, the first image being characterized by a first dimension;
generating a first plurality of patches using the first image;
generating a second image based on the first image, the second image being characterized by a second dimension, the second dimension being lower than the first dimension;
extracting a textual embedding using the plurality of text data;
generating a plurality of visual embeddings using at least the first plurality of patches and the second image;
performing object recognition using at least the plurality of visual embeddings and the textual embedding;
generating one or more labels based on the object recognition; and
storing the one or more labels.

10. The method of claim 9 further comprising generating a first key and a first value using at least the plurality of visual embeddings.

11. The method of claim 9 further comprising generating a first query using at least the textual embedding.

12. The method of claim 9 further comprising calculating a correlation between the textual embedding and the plurality of visual embeddings.

13. The method of claim 9 wherein two adjacent patches of the first plurality of patches are partially overlapped.

14. The method of claim 9 wherein the first dimension of the first image is greater than 224×224.

15. An image labeling system, the system comprising:
a communication interface configured to receive an input image;
a memory coupled to the communication interface, the memory configured to store the input image;
a processor coupled to the memory, the processor being configured for:
obtaining a first plurality of patches by dividing the first input image;
generating a first intermediate image by performing down-sampling using the input image, the first intermediate image being characterized by a second dimension, the second dimension being smaller than the first dimension;
obtaining a second plurality of patches by dividing the first intermediate image;
generating a second intermediate image by performing down-sampling using the first intermediate image, the second intermediate image being characterized by a third dimension, the third dimension being smaller than the second dimension;
performing object recognition using at least the first plurality of patches and the second plurality of patches;
generating one or more labels based on the object recognition.

16. The system of claim 15 wherein the processor comprises a central processing unit (CPU).

17. The system of claim 15 wherein the processor comprises a neural processing unit (NPU) and/or a graphics processing unit (GPU).

18. The system of claim 15 wherein the processor is further configured for embedding the one or more labels in an output image.

19. The system of claim 18 further comprising a data storage configured to store the one or more labels and the output image.

20. The system of claim 15 wherein the processor is further configured for obtaining a plurality of feature tokens using at least the first plurality of the patches and the second plurality of patches.
